(19) United States
(12) Patent Application Publication
(10) Pub. No.: US 2018/0050911 A1
(43) Pub. Date: Feb. 22, 2018

(54) SYSTEM AND METHOD FOR BREEDING TRITIUM FROM LITHIUM USING A NEUTRON GENERATOR

(71) Applicant: Global Medical Isotope Systems LLC, Henderson, NV (US)

(72) Inventor: Francis Yu-Hei Tsang, Las Vegas, NV (US)

(21) Appl. No.: 15/682,188

(22) Filed: Aug. 21, 2017

Related U.S. Application Data
(60) Provisional application No. 62/378,078, filed on Aug. 22, 2016.

(51) Int. Cl. C01B 4/00; H05H 3/06; G21G 4/02; G21C 1/02

(52) U.S. Cl. CPC C01B 4/00; H05H 3/06; G21C 3/42; G21C 1/02; Y02E 30/34; G21G 4/02

(57) ABSTRACT

A system and method for producing tritium are disclosed. The system includes at least one neutron generator configured to generate neutrons. The system further includes at least one target comprising a lithium-containing material. The at least one target is configured to be irradiated by at least some of the neutrons and to produce tritium. The system further includes at least one collection structure configured to receive at least some of the tritium from the at least one target. The at least one collection structure comprises at least one gas conduit having an input configured to receive a carrier gas and an output configured to allow the carrier gas and the received tritium to flow out of the at least one gas conduit after the carrier gas has flowed along the at least one target.

### CROSS-REFERENCE TO RELATED APPLICATIONS

This application claims the benefit of U.S. Provisional Appl. No. 62/378,078, filed on Aug. 22, 2016 and incorporated in its entirety by reference herein.

### STATEMENT REGARDING FEDERALLY SPONSORED R&D

Some of the work described in this disclosure was made with United States Government support under National Securities Technologies LLC Task Order No. 186303, Subcontract No. 291886-DL-17, awarded under the authority of the U.S. Department of Energy. The United States Government may have certain rights in inventions disclosed herein.

### BACKGROUND

### Field

This application relates generally to the production (e.g., generation and collection) of radioactive, nuclear isotopes (often referred to as radioisotopes), and more particularly to systems and methods for producing (e.g., generating and collecting) tritium.

### Description of the Related Art

Historic (e.g., conventional; traditional) methods for special isotope production typically require the total dissolution of the target after an extended irradiation period, and very elaborated separation processes are required to recover the desired isotopes.

Historic (e.g., conventional; traditional) tritium production typically requires the dissolution of specially prepared lithium targets. Such methods require the manufacturing of specially designed lithium compounds as target materials and then irradiating the targets in a nuclear reactor. After a predetermined irradiation period, the targets are removed from the reactor and then tritium is recovered by dissolving the entire lithium target. Such historic (e.g., conventional; traditional) methods requires special manufacturing, handling, and material disposal throughout the entire production cycle.

### SUMMARY

Certain embodiments described herein provide a system for producing tritium. The system comprises at least one neutron generator configured to generate neutrons. The system further comprises at least one target comprising a lithium-containing material. The at least one target is configured to be irradiated by at least some of the neutrons and to produce tritium. The system further comprises at least one collection structure configured to receive at least some of the tritium from the at least one target. The at least one collection structure comprises at least one gas conduit having an input configured to receive a carrier gas and an output configured to allow the carrier gas and the received tritium to flow out of the at least one gas conduit after the carrier gas has flowed along the at least one target.

Certain embodiments described herein provide a method for producing tritium. The method comprises irradiating at least one target with neutrons. The at least one target comprises a lithium-containing material, and the at least one target is configured to produce tritium in response to neutron irradiation. The method further comprises flowing a carrier gas along the at least one target. The carrier gas is configured to receive at least some of the tritium. The method further comprises collecting the carrier gas and the received tritium after the carrier gas has flowed along the at least one target.

Certain embodiments described herein provide a system for producing tritium. The system comprises means for irradiating at least one target with neutrons. The at least one target comprises a lithium-containing material, and the at least one target is configured to produce tritium in response to neutron irradiation. The system further comprises means for flowing a carrier gas along the at least one target. The carrier gas is configured to receive at least some of the tritium. The system further comprises means for collecting the carrier gas and the received tritium after the carrier gas has flowed along the at least one target.

### BRIEF DESCRIPTION OF THE DRAWINGS

FIG. 1A schematically illustrates an example system for producing tritium in accordance with certain embodiments described herein.

FIG. 1B schematically illustrates another example system for producing tritium in accordance with certain embodiments described herein.

FIG. 2A is a plot of the cross-sections for various nuclear reactions utilizing a deuterium beam as a function of the kinetic energy of the deuterium ions, some of the nuclear reactions resulting in neutron generation in accordance with certain embodiments described herein.

FIG. 2B is a plot of the relative intensities of neutron generation, as functions of the kinetic energy from the D+D, D+T, and T+T nuclear reactions of FIG. 2A, in accordance with certain embodiments described herein.

FIG. 2C is a plot of neutron spectrum from the combined nuclear reactions of FIG. 2B (denoted by a dashed line) in accordance with certain embodiments described herein.

FIG. 3A is a plot of the cross section (in barns) for tritium production by irradiating natural lithium (e.g., having about 7.5% ⁶Li and 92.5% ⁷Li) with neutrons as a function of neutron incident energy (in MeV) in accordance with certain embodiments described herein.

FIG. 3B is a plot of the cross section (in barns) for tritium production for various reactions by irradiating natural lithium (e.g., having about 7.5% ⁶Li and 92.5% ⁷Li) with neutrons as a function of neutron incident energy (in MeV) in accordance with certain embodiments described herein.

FIG. 3C is a plot of the cross section (in barns) for ⁷Li nuclear reactions for neutron irradiation of natural lithium (e.g., having about 7.5% ⁶Li and 92.5% ⁷Li) as a function of neutron incident energy (in MeV) in accordance with certain embodiments described herein.

FIG. 3D is a plot of the cross section (in barns) for D+⁶Li and D+⁷Li nuclear reactions for neutron irradiation of natural lithium (e.g., having about 7.5% ⁶Li and 92.5% ⁷Li) as a function of neutron incident energy (in MeV) in accordance with certain embodiments described herein.

FIG. 4 which shows a natural lithium metal sample encapsulated in a small container and submerged in mineral oil in accordance with certain embodiments described herein.

FIG. 5 shows an example lithium foil for an example lithium foil target in accordance with certain embodiments described herein.

FIG. 6A schematically illustrates an example apparatus for forming a target comprising lithium foil in accordance with certain embodiments described herein.

FIG. 6B schematically illustrates an example spiral target in accordance with certain embodiments described herein.

FIG. 7A-7D schematically illustrate example collection structures configured to receive at least some of the tritium from the at least one target in accordance with certain embodiments described herein.

FIG. 7E schematically illustrates an example target compatible to be used with the collection structures of FIGS. 7A-7D.

FIG. 8 schematically illustrates an example separation structure in accordance with certain embodiments described herein.

FIG. 9A is a schematic side view of an example system in accordance with certain embodiments described herein.

FIG. 9B is a schematic top view of the example system of FIG. 9A in accordance with certain embodiments described herein.

FIG. 10 is a schematic view of a plurality of lithium-containing elongate structures to be used as targets in accordance with certain embodiments described herein.

FIG. 11 is a schematic top view of another example system in accordance with certain embodiments described herein.

### DETAILED DESCRIPTION

Certain embodiments described herein include a system and method for producing (e.g., generating and collecting) tritium from lithium (e.g., natural lithium metal; lithium oxide). In certain embodiments, the system comprises at least one neutron generator (e.g., a “limitless-life” neutron generator) and at least one target comprising lithium and configured to be irradiated (e.g., bombarded) with neutrons from the at least one neutron generator. Certain embodiments include a neutron multiplier (e.g., beryllium; depleted uranium) which increases the number of neutrons irradiating the at least one target, thereby enhancing the tritium production from the lithium of the at least one target. Certain embodiments include at least one neutron reflector (e.g., graphite) which reflects at least a portion of the neutrons from the at least one neutron generator towards the at least one target, thereby enhancing the tritium production from the lithium of the at least one target.

In certain embodiments, the system and method for tritium production leverages on the success of a previously patented Mo-99 production methodology which utilizes a neutron generator (see, e.g., U.S. Pat. No. 9,047,997, incorporated in its entirety herein). One feature of this previously patented Mo-99 production methodology is its use of target materials with total surface areas that are at least 4 to 5 orders of magnitude greater than that of a single historical (e.g., conventional; traditional) target. Certain embodiments described herein utilize certain prescribed design features of thin lithium foils coupled to a neutron generator (e.g., a neutron generator as described in U.S. Pat. No. 9,047,997), such that the produced tritium nuclei (e.g., tritons) easily diffuse, migrate, and escape from the surfaces of the thin lithium foils. Certain such embodiments advantageously allow in-situ continual production and collection of tritium gas.

In previous tritium generation systems, deuterated titanium targets had short bombardment times and frequent change outs (e.g., after a few hours). Certain embodiments described herein advantageously provide low contamination and continuous irradiation operations and enhanced potential for continual extraction of tritium.

The following terms as used in the description herein have their broadest reasonable interpretations and are to be interpreted broadly:
Non-enriched uranium (“NEU”) or depleted uranium;
Neutron-multiplying material or neutron multiplier
Neutron-reflecting material or neutron reflector;
Fast neutron fission or fast fission; and
Neutron generator.

The terms “non-enriched uranium” (“NEU”) and “depleted uranium” (“DU”) have their broadest reasonable interpretation and are intended to cover naturally occurring uranium, in addition to any uranium that contains at least as much U-238 as naturally occurring uranium (99.27%) and no more U-235 than naturally occurring uranium (0.72%). Depleted uranium is normally understood to mean uranium that has less than the naturally occurring amount of U-235 (0.72%), but depleted uranium that is used for commercial and military purposes more commonly has less than 0.3% U-235. The terms of NEU and DU are not limited to any form of the uranium, so long as the isotope content meets the above criteria. Such materials can be in the form of bulk solid material, crushed solid material, metallic shavings, metallic filings, sintered pellets, liquid solutions, molten salts, molten alloys, or slurries, and, whatever its form, can also be mixed with other materials that are compatible with the intended use.

The terms “neutron-multiplying material” and “neutron multiplier” have their broadest reasonable interpretation and are intended to cover materials that generate more neutrons in response to irradiation by neutrons. Further, while some of the embodiments use neutron-multiplying materials formed into solid structural shapes such as plates, spherical shells, cylindrical shells, tubes, and the like, the term is intended to cover materials that includes small particles such as powders, pellets, shavings, filings, and the like.

The terms “neutron-reflecting material” and “neutron reflector” have their broadest reasonable interpretation and are intended to cover materials that reflects or scatters neutrons. While it is preferred in certain embodiments that the scattering be elastic, or largely so, this is not necessary for the definition. Further, while some of the embodiments use neutron-reflecting materials formed into solid structural shapes such as plates, spherical shells, cylindrical shells, tubes, and the like, the term is intended to cover materials that includes small particles such as powders, pellets, shavings, filings, and the like.

The terms “fast neutron fission” and “fast fission” have their broadest reasonable interpretation and are intended to cover fission reactions that are caused by neutrons with energies that are above the threshold of 800 keV.

The term “neutron generator” has its broadest reasonable interpretation and is intended to cover a wide range of devices and processes for generating neutrons of the desired energies, including but not limited to: neutron source devices which contain compact linear accelerators and that produce neutrons by fusing isotopes of hydrogen together. The fusion reactions taking place in such devices can be initiated by accelerating either deuterium, tritium, or a mixture of these two isotopes into a metal hydride target which also contains either deuterium, tritium or a mixture. As used herein, the term “neutron generator” is defined broadly to include any device that would provide a sufficient number of neutrons of the desired energies.

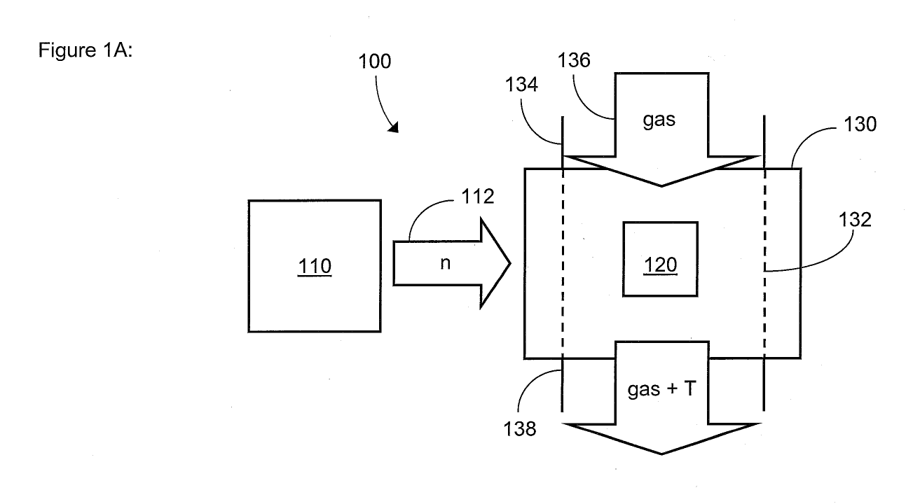

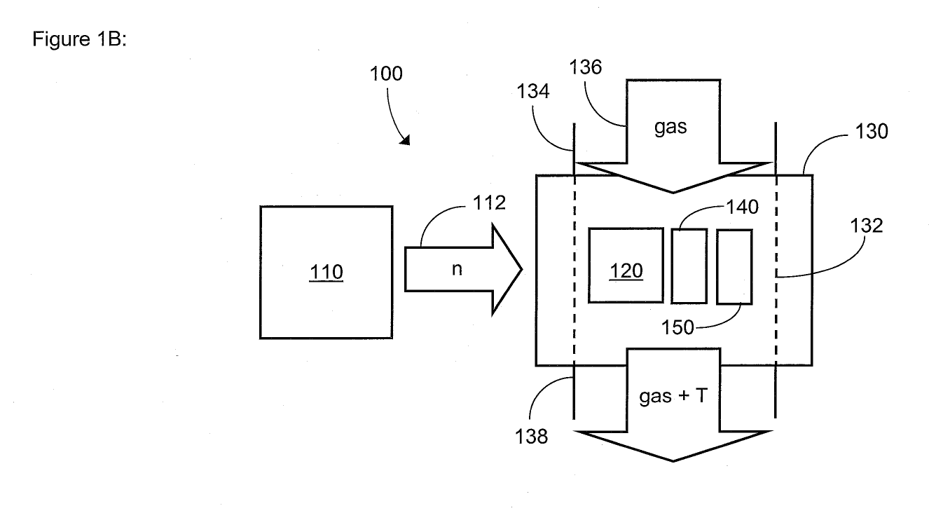

FIG. 1A schematically illustrates an example system 100 for producing tritium in accordance with certain embodiments described herein. The system 100 comprises at least one neutron generator 110 configured to generate neutrons 112. The system 100 further comprises at least one target 120 comprising a lithium-containing material (e.g., lithium metal or lithium oxide). The at least one target 120 is configured to be irradiated by at least some of the neutrons 112 and to produce tritium. The system 100 further comprises at least one collection structure 130 configured to receive at least some of the tritium from the at least one target 120. The at least one collection structure 130 comprises at least one gas conduit 132 having an input 134 configured to receive a carrier gas 136 and an output 138 configured to allow the carrier gas 136 and the received tritium to flow out of the at least one gas conduit 132 after the carrier gas 136 has flowed along the at least one target 120 (e.g., along the lithium-containing material; along a surface of lithium foil; along a surface of the lithium metal or lithium oxide).

FIG. 1B schematically illustrates another example system 100 for producing tritium in accordance with certain embodiments described herein. The system 100 comprises at least one neutron generator 110, at least one target 120, and at least one collection structure 130, and further comprises at least one neutron multiplier 140 and at least one neutron reflector 150. The at least one neutron multiplier 140 is configured to generate neutrons in response to being irradiated by neutrons, and the at least one neutron reflector is configured to redirect at least some neutrons impinging the at least one neutron reflector. The at least one target 120 is configured to be irradiated by at least some of the neutrons from the at least one neutron multiplier 140 and at least some of the neutrons redirected by the at least one neutron reflector 150.

### Example Neutron Generators

In certain embodiments, the at least one neutron generator 110 is configured to generate neutrons 112 for irradiating the at least one target 120. Examples of the at least one neutron generator 110 compatible with certain embodiments described herein include, but are not limited to, one or more of the following:
DD-109 neutron generator (sometimes referred to herein as a “limitless-life” neutron generator) marketed by Adelphi Technology Inc., 2003 East Bayshore Rd., Redwood City, Calif. 94063. Certain such neutron generators can emit about 3×10⁹ neutrons/second. Certain such “limitless-life” neutron generators use a continuous gas stream to produce a plasma and deuterium beam, capable of providing over one thousand hours of non-stop irradiations.
Neutron generator as described in U.S. Pat. No. 9,047,997, which is incorporated in its entirety by reference herein.
Fixed target neutron generator, e.g., as described in G. Voronin, et al., “Development of the Intense Neutron Generator SNEG-13,” Proceedings of the EPAC94, Jun. 27-Jul. 1, 1994, London, V. 3, pp. 2678-2680.
Neutron generator which produce neutrons as a result of a beam of deuterium ions irradiating a target comprising deuterons and/or tritium (e.g., metallic tritide; titanium tritide).

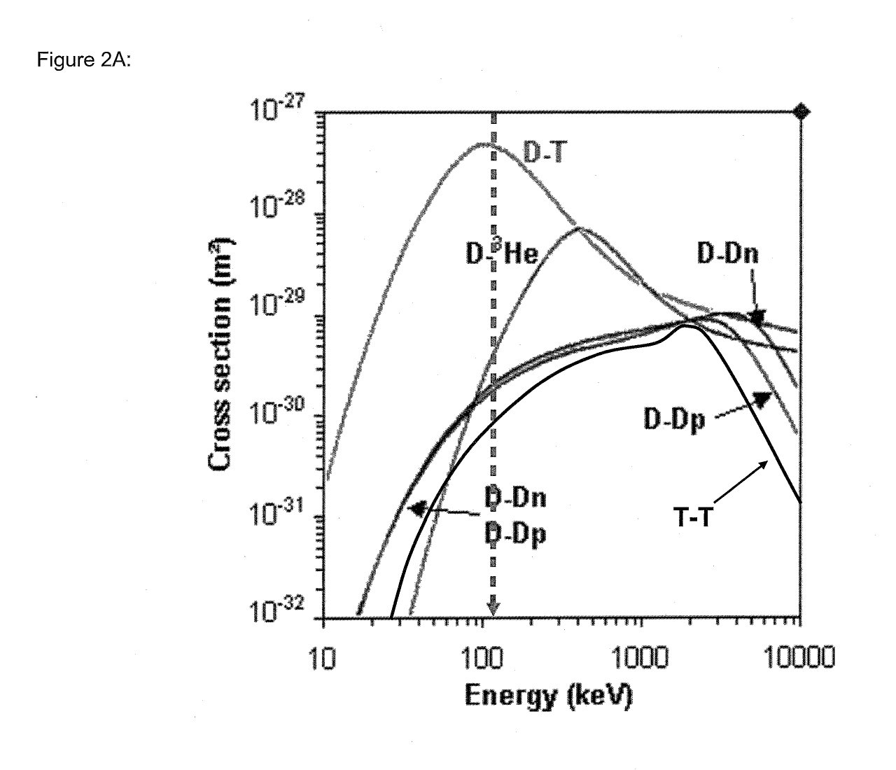

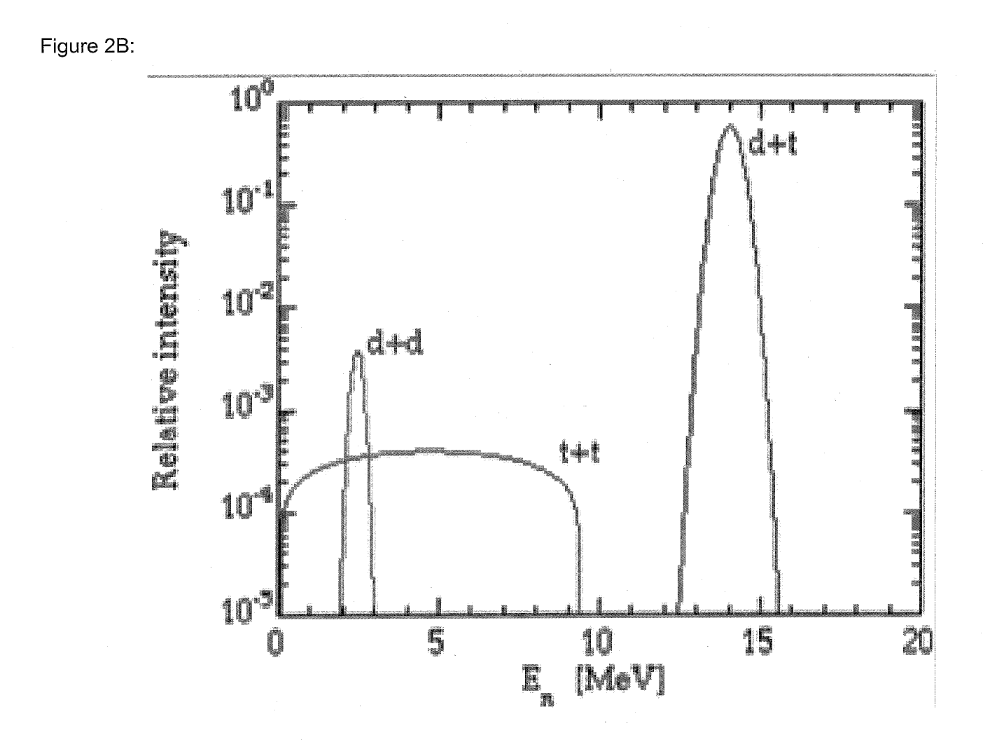

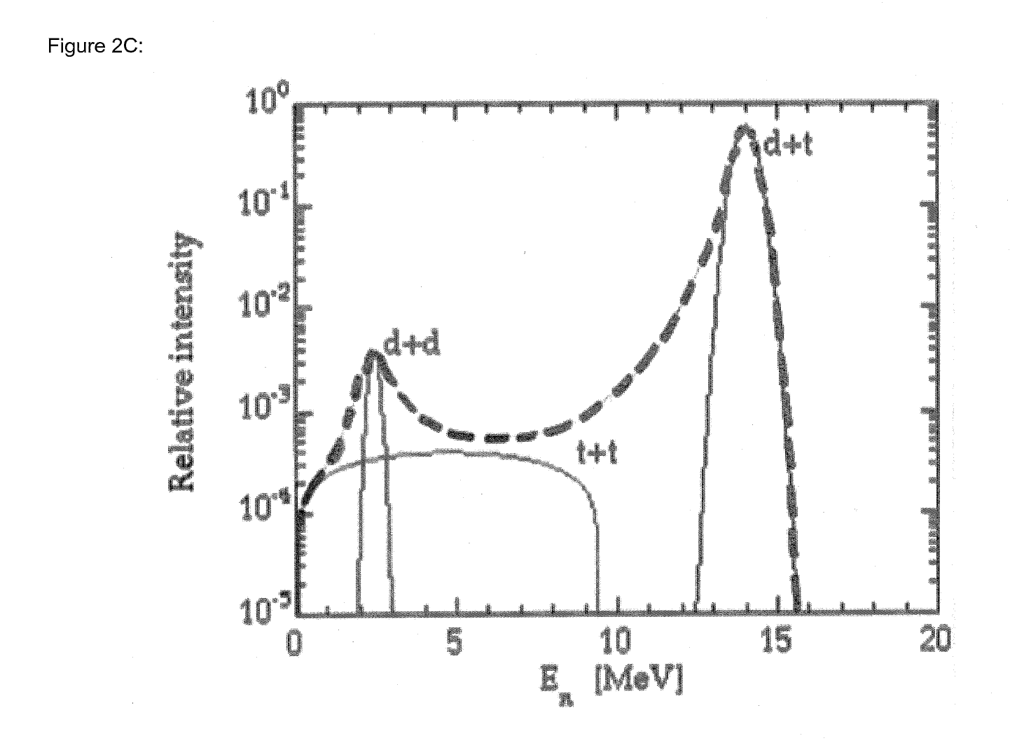

FIG. 2A is a plot of the cross-sections for various nuclear reactions utilizing a deuterium beam as a function of the kinetic energy of the deuterium ions, some of the nuclear reactions resulting in neutron generation in accordance with certain embodiments described herein. The nuclear reactions plotted in FIG. 2A include the following:
D+D (neutron branch)→³He+n+2.45 MeV (representing about 50% of the total D+D reactions up to about 4 MeV; denoted in FIG. 2A by “D-Dn”)
D+D (proton branch)→T+p+3.02 MeV (representing about 50% of the total D+D reactions up to about 4 MeV; denoted in FIG. 2A by “D-Dp”)
D+T→⁴He+n+14.1 MeV
D+³He→⁴He+p+14.6 MeV
   In addition, some neutrons may be generated by the nuclear reaction of T+T→⁴He+2n+11.3 MeV. The dashed line of FIG. 2A denotes a kinetic energy of between 120 keV and 125 keV, which is compatible with operation of the “limitless-life” DD-109 neutron generator marketed by Adelphi Technology Inc.

FIG. 2B is a plot of the relative intensities of neutron generation, as functions of the kinetic energy from the D+D, D+T, and T+T nuclear reactions of FIG. 2A, in accordance with certain embodiments described herein. FIG. 2C is a plot of neutron spectrum from the combined nuclear reactions of FIG. 2B (denoted by a dashed line) in accordance with certain embodiments described herein. While absolute measurements have not been performed, the dashed line represents an approximation of the anticipated combined neutron intensity spectra from the three fusion reactions. Table 1 lists the nuclear reactions and their energy releases.

TABLE 1

| | | | Energy |
|---|---|---|---|
| Nuclear | Branching | | Yield |
| reaction | Ratio (%) | Products | (MeV) |
| D + Dp | 50 | T (1.01 MeV) + p (3.02 MeV) | 4.03 |
| (proton | | | |
| branch) | | | |
| D + Dn | 50 | ³He (0.82 MeV) + n (2.54 MeV) | 3.27 |
| (neutron | | | |
| branch) | | | |
| D + T | | ⁴He (3.54 MeV) + n (14.06 MeV) | 17.6 |
| D + ³He | | ⁴He (3.66 MeV) + p (14.6 MeV) | 18.3 |
| T + T | | ⁴He (2.1 MeV) + 2n (9.2 MeV) | 11.3 |
| ³He + T | 51 | ⁴He + p + n + 12.1 MeV | 12.1 |
| | 43 | ⁴He (4.8 MeV) + D (9.5 MeV) | 14.3 |
| | 6 | ⁵He (2.4 MeV) + p (11.9 MeV) | 11.4 |
| ³He + ³He | | He + p + p | 12.9 |
| | | | ΔE = |
| | | | 105.2 MeV |

Reactions with kinetic energies greater than 50 keV can be referred to as DD catalyzed reactions. For reactions with kinetic energies less than 50 keV, the reaction D+³He is not significant. Across these nuclear reactions, 6D are fused, generating 2 p, 2 ⁴He, and 2 n, and releasing energy of 43.2 MeV or about 43/6=7.2 MeV per D. T and ³He can act as catalysts in the overall reactions. The two neutrons have energies at: 2.54 MeV and 14.1 MeV. The T+T reaction can also be important in terms of total neutron production, producing a white neutron spectrum with the 9.2 MeV distributed between the two neutrons. As a result, each of the two neutrons can have energy ranges from 0 to 9.2 MeV (e.g., one neutron has an energy of E₁, with E₁ in a range from 0 to 9.2 MeV and the other neutron has an energy of E₂=9.2 MeV−E₁, with E₂ in a range from 0 to 9.2 MeV).

### Example Targets

Certain embodiments described herein utilize at least one target 120 configured to be irradiated by at least some of neutrons 112 generated and emitted by the at least one neutron generator 110 and to produce tritium. Examples of the at least one target 120 compatible with certain embodiments described herein include, but are not limited to, one or more of the following:
Natural lithium materials (e.g., 7.5% ⁶Li);
   Lithium can be in solid or liquid form, e.g., metal, molten, or compounds (e.g., sintered);
Enriched lithium materials (e.g., having a higher percentage of ⁶Li than occurs in natural lithium; e.g., any combinations of percentages of ⁶Li and ⁷Li in which the ⁶Li percentage is greater than 7.5%; can have percentage of ⁶Li as high as 100%);
   Enriched lithium can be in solid or liquid form, e.g., metal, molten, or compounds (e.g., sintered);
Lithium oxide (e.g., lithium oxide blanket configurations);
   Lithium oxide (e.g., LiO₂) can be in the form of pellets or powders;
Other forms or compounds comprising lithium
   e.g., liquid eutectic (e.g., Pb—Li); molten salts (e.g., F—Li—Be; F—Li—NaBe); solid Li-ceramics (e.g., Li₄SiO₄; Li₂TiO₃; Li₂O; LiHCO₃; Li₂Cr₂O₇; Li₂CrO₄; Li₃P; Li₂HPO₄; LiNO₂; Li₂CO₃; Li₂SO₄; LiHSO₃; Li₂C₂O₄; Li₂SO₃; LiCl; LiI; LiOH; Li₃N; Li₂S; LiBr; LiNO₃; LiF; LiHSO₄; Li₂S₂O₃; LiNO₃; LiH₂PO₄; LiCH₃COO; LiClO₂; LiSCN; LiClO₃).

For example, the at least one target 120 can comprise lithium metal or lithium oxide containing lithium having about 7.5% ⁶Li and 92.5% ⁷Li, having more than 7.5% ⁶Li and less than 92.5% ⁷Li, an isotope abundance ratio of ⁶Li:⁷Li equal to or greater than a naturally-occurring isotope abundance ratio of ⁶Li:⁷Li (e.g., equal to or greater than 7.5:92.5).

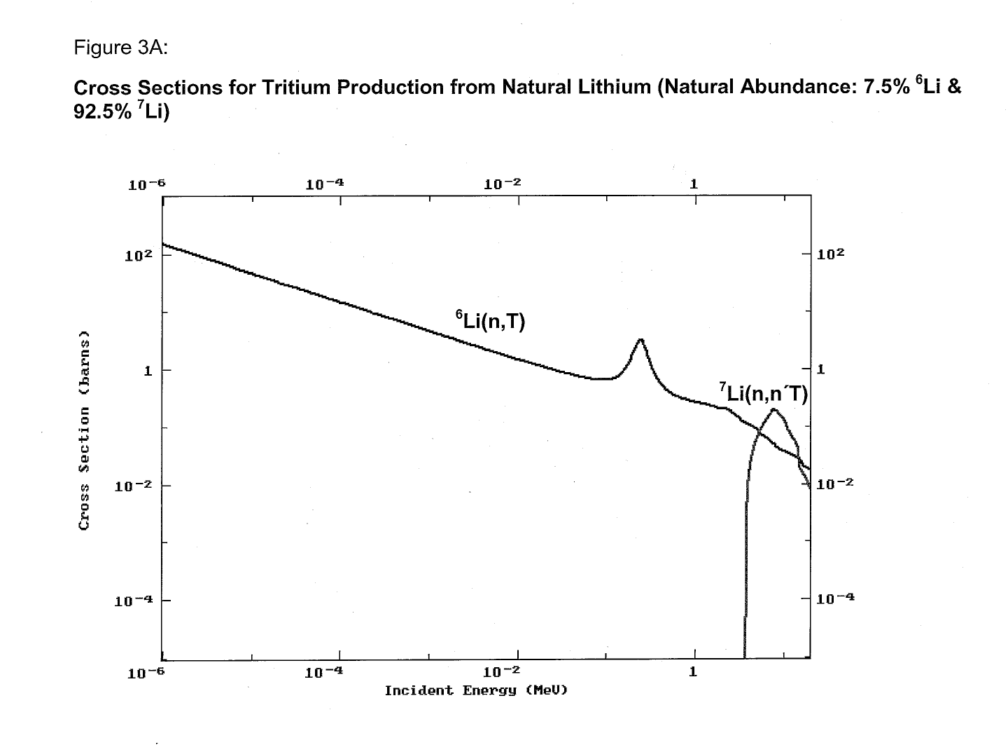

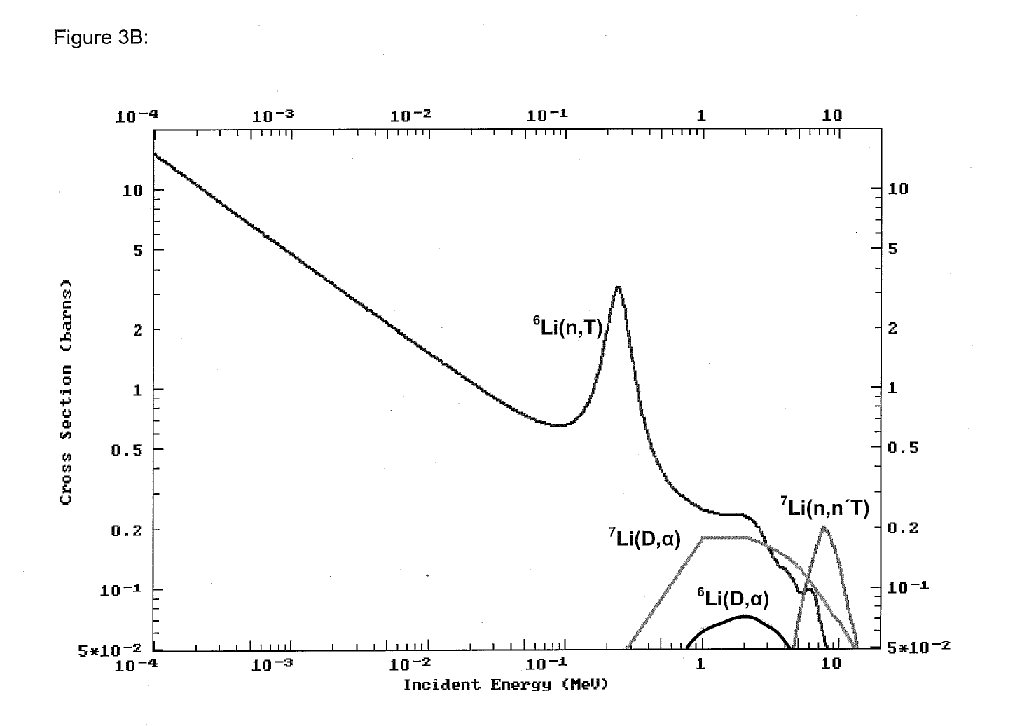

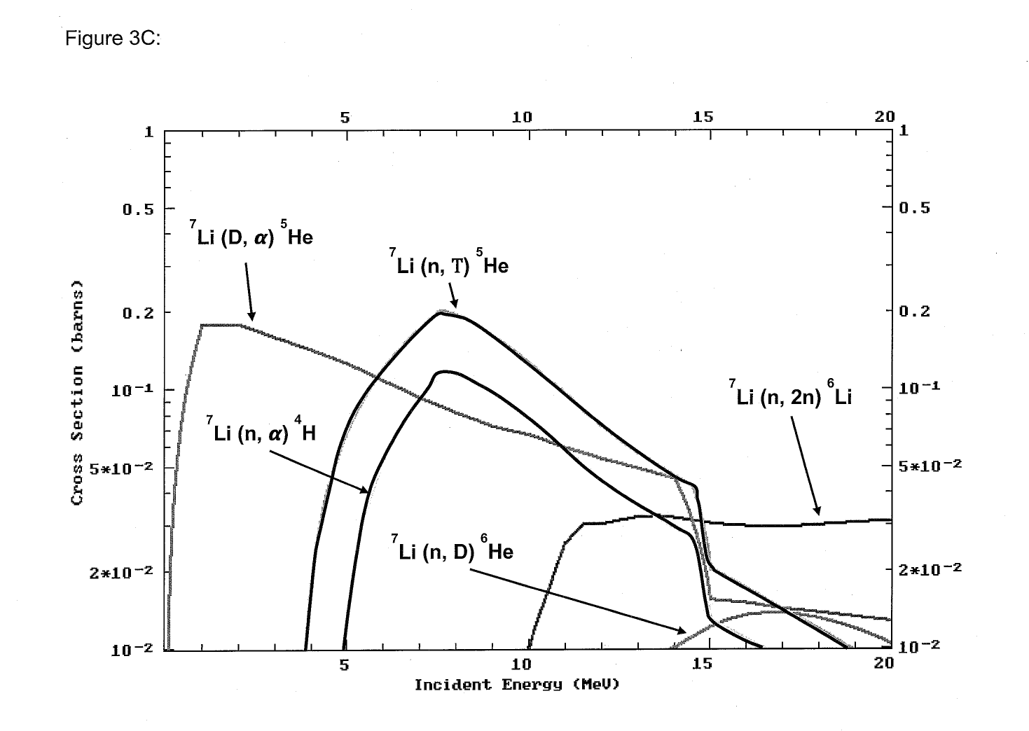

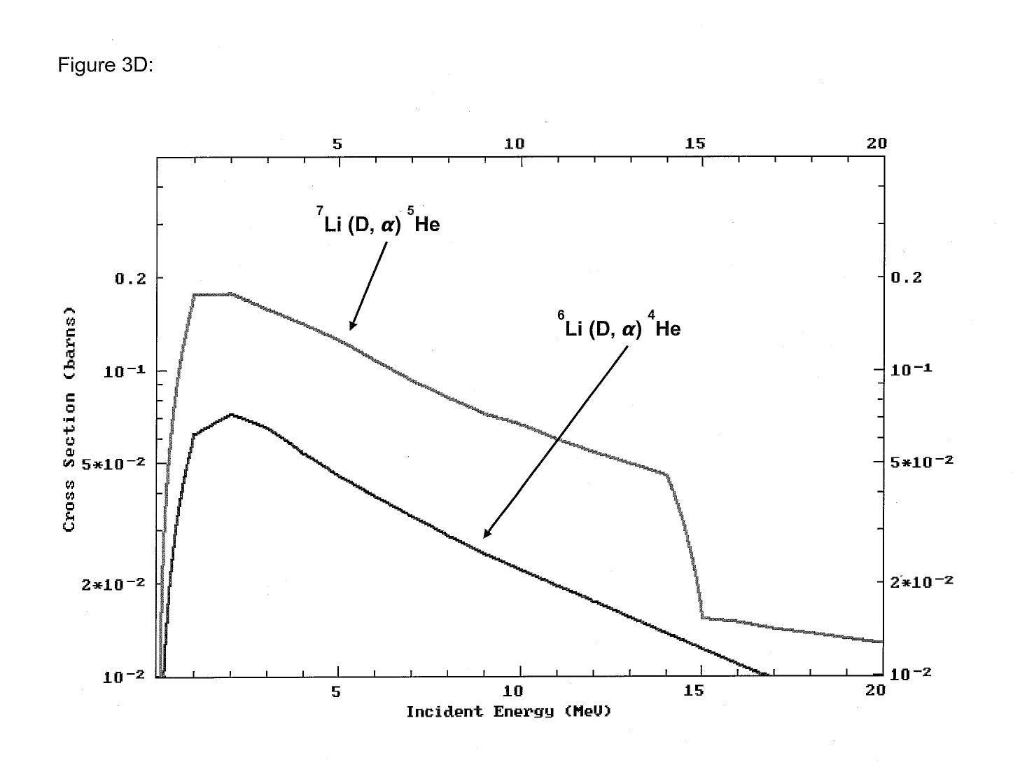

In certain embodiments, natural lithium metal, containing about 7.5% ⁶Li and 92.5% ⁷Li, can be used as the target material. FIG. 3A is a plot of the cross section (in barns) for tritium production by irradiating natural lithium (e.g., having about 7.5% ⁶Li and 92.5% ⁷Li) with neutrons as a function of neutron incident energy (in MeV) in accordance with certain embodiments described herein. The plot of FIG. 3A includes a first line showing the cross section for tritium production via the ⁶Li(n, t) reaction and a second line showing the cross section for tritium production via the ⁷Li(n, n′T) reaction. In certain embodiments in which the at least one target 120 comprise natural lithium, the ⁶Li can be the primary source material for tritium production for a range of neutron energies below about 5 MeV. Table 2 lists the nuclear reactions for neutrons and natural lithium, along with their energy releases. The first two reactions listed in Table 2 can be considered to happen simultaneously to generate two tritons to form tritium gas and can be expressed as: n+⁶Li+⁷Li→T+T+⁴He+⁴He.

TABLE 2

| | | Energy |
|---|---|---|
| | | Yield |
| Nuclear reaction | Products | (MeV) |
| ⁶Li (n, T) ⁴He | ⁴He (2.05 MeV) + T (2.73 MeV) | 4.78 |
| ⁷Li (n, n, T) ⁴He | ⁵He (2.1 MeV) + T (2.7 MeV) | −2.47 |
| | ⁵He → n + α (t_{1/2} = 2 × 10⁻²¹ s) | |
| ⁶Li (n, D) ⁵He | ⁵He → n + α | −2.21 |
| ⁶Li (D, α) ⁴He | ⁴He + ⁴He | 22.40 |
| ⁶Li (n, 2n) ⁵Li | ⁵Li → p + α | −5.66 |
| ⁷Li (p, n) ⁷Be | ⁷Be | −1.64 |
| | ⁷Be + ⁴He → ¹¹C + γ (t_{1/2} = 53.3 d) | (7.54) |
| ⁷Li (n, D) ⁶He | ⁶He → ⁶Li + β⁻ (t_{1/2} = 0.8 s) | −7.75 |
| ⁷Li (D, α) ⁵He | ⁵He + ⁴He | 14.39 |
| | ⁵He → n + α (t_{1/2} = 2 × 10⁻²¹ s) | |
| ⁷Li (n, ⁵He) T | ⁵He (2.1 MeV) + T (2.7 MeV) | −3.20 |
| | ⁵He → n + α (t_{1/2} = 2 × 10⁻²¹ s) | |
| ⁷Li (n, 2n) ⁶Li | ⁶Li + n + n | −7.25 |
| ⁷Li (n, α) ⁴H | ⁴H | −4.07 |
| | ⁴H → T + n (t_{1/2} = 1.4 × 10⁻²² s) | |
| | | ΔE = |
| | | 7.32 MeV |

FIG. 3B is a plot of the cross section (in barns) for tritium production for various reactions listed in Table 2 by irradiating natural lithium (e.g., having about 7.5% ⁶Li and 92.5% ⁷Li) with neutrons as a function of neutron incident energy (in MeV) in accordance with certain embodiments described herein. FIG. 3C is a plot of the cross section (in barns) for ⁷Li nuclear reactions for neutron irradiation of natural lithium (e.g., having about 7.5% ⁶Li and 92.5% ⁷Li) as a function of neutron incident energy (in MeV) in accordance with certain embodiments described herein. FIG. 3D is a plot of the cross section (in barns) for D+⁶Li and D+⁷Li nuclear reactions for neutron irradiation of natural lithium (e.g., having about 7.5% ⁶Li and 92.5% ⁷Li) as a function of neutron incident energy (in MeV) in accordance with certain embodiments described herein.

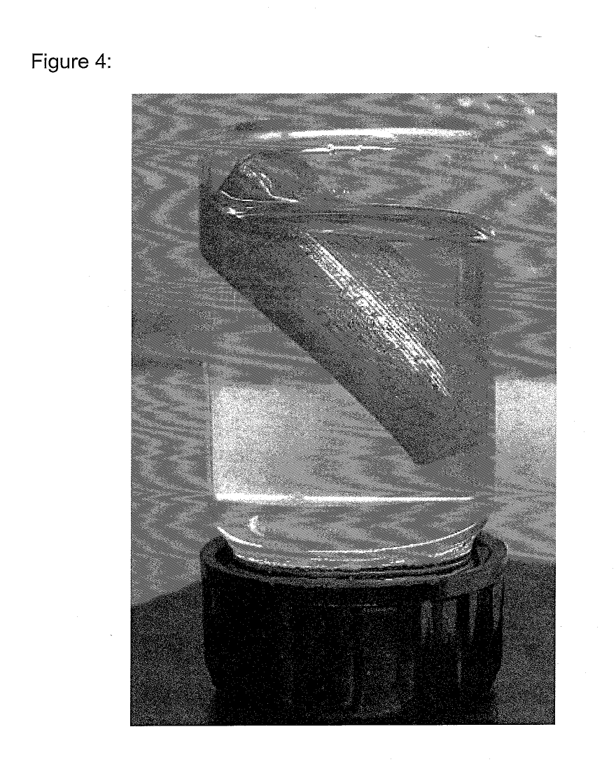

In certain embodiments, using at least one target 120 comprising natural lithium metal can provide one or more of the following advantages:
Capable of being purchased on-line from commercial suppliers, thereby potentially shortening deliverables times (see, e.g., https://unitednuclear.com/index.php?main_page=page&id=25&zenid=584e0975a2475780acac08b602291872);
Shipped in small containers in which the lithium is encapsulated and submerged in mineral oil (see, e.g., FIG. 4 which shows a natural lithium metal sample encapsulated in a small container and submerged in mineral oil);
Minimizing contamination;
Ease of sample handling and change-outs;
Tritium counting can be accomplished without taking the lithium metal outside the small containers. For example, since the produced tritium atoms can be released and flow into the air-space of the container and their activities can be easily determined using one or more residual gas analyzer (RGA) spectrometers. For another example, certain amount of the produced tritium atoms will exchange with the hydrogen atoms in the oil, so the activities of the oil can be measured using one or more beta spectrometers. In certain embodiments, the resulting total activities produced from multiple samples can be used to correlate the specific sample locations with different neutron energy regimes.

In certain embodiments, lithium metal targets 120 can be formed using lithium carbonate, which is an inorganic compound, the lithium salt of carbonate with the formula Li₂CO₃. This white salt is widely used in the processing of metal oxides. Lithium carbonate (Li₂CO₃) exists only in the anhydrous form (see, e.g., Greenwood, N. N.; & Earnshaw, A. (1997), Chemistry of the Elements (2nd Edn.), Oxford: Butterworth-Heinemann. Pages 84-85, ISBN 0-7506-3365-4). In other words, water molecules are not bound or attached to the compound as a hydrate.

In certain embodiments, a room-temperature ionic liquid (RTIL) can be used to dissolve the enriched ⁶Li₂CO₃ compound and through electrochemistry to collect the ⁶Li metal onto electrodes. For example, the RTIL can be de-hydrated and electrochemical deposition of ⁶Li metal onto electrodes (Au or Graphite) can be performed. In this way, in the conversion of the ⁶Li₂CO₃ compound to ⁶Li metal, no oxygen atoms are presented or get carried over when formation of the metal occurs according to: 2H⁺+2RTIL⁻+⁶Li₂CO₃→2 Li-RTIL (complex)+H₂O+CO₂ (water and carbon dioxide are off-gassed and removed in the process to deposit lithium metal by Ar purging, roto-evaporation, and/or water gettering prior to deposition). Preparation of the Li ionic liquid can be achieved by direct dissolution or cation exchange on a column very easily. ⁶Li-RTIL→⁶Li metal can be yielded on an over-potential in the RTIL matrix selected which can be collected, pressed into pellets, then in the form for use directly to be neutron irradiated and resulting formation of tritium during breeding. The ⁶Li₂ metal can be transferred into one or more quartz tubes (e.g., 10 cm in length×1.5 cm in diameter, with wall thicknesses of about 0.2 cm) under an inert gas atmosphere and sealed at both ends. For example, 20 tubes can be made with each tube containing about 2 Moles of ⁶Li (˜12 grams). Regarding the conversion, 72 grams of ⁶Li₂CO₃=>1 Mole, and 1 Mole of ⁶Li₂CO₃ produces 2 Moles of ⁶Li metal=>12 grams.

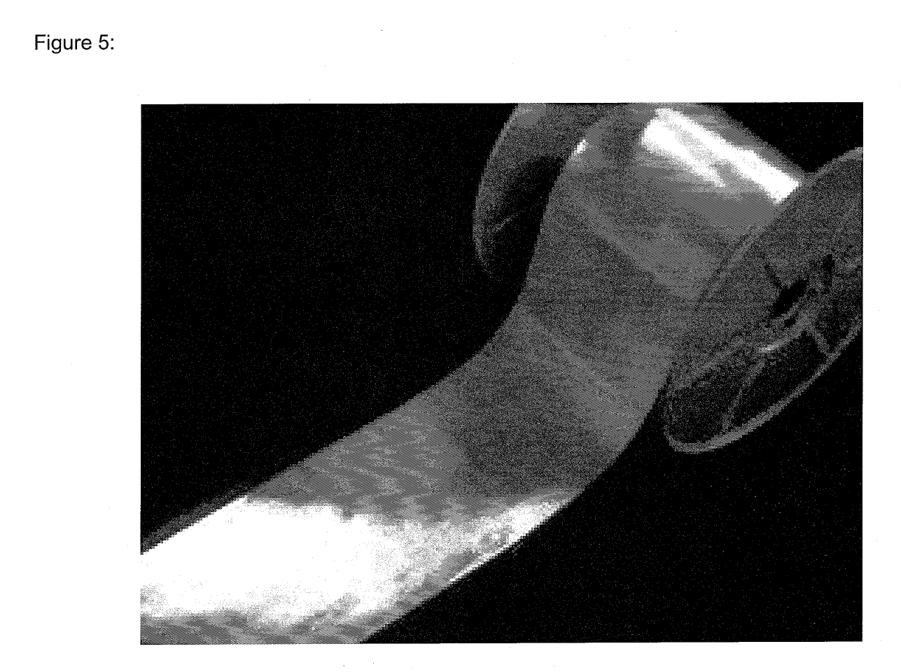

In certain embodiments, the at least one target 120 can comprise lithium foil. FIG. 5 shows an example of Lib-LiF-30m lithium foil from MTI Corp. of Richmond, Calif. for an example lithium foil target 120 in accordance with certain embodiments described herein. This lithium foil is in the form of a roll of foil having a length of 30 meters, a width of 3.5 cm, and a thickness of 0.017 cm, a total mass of 96 grams, a purity of about 99.99%, and a total surface area of about 21,000 cm². Lithium foils with other dimensions are also compatible with certain embodiments described herein. In addition, other forms of lithium are also compatible with certain embodiments described herein.

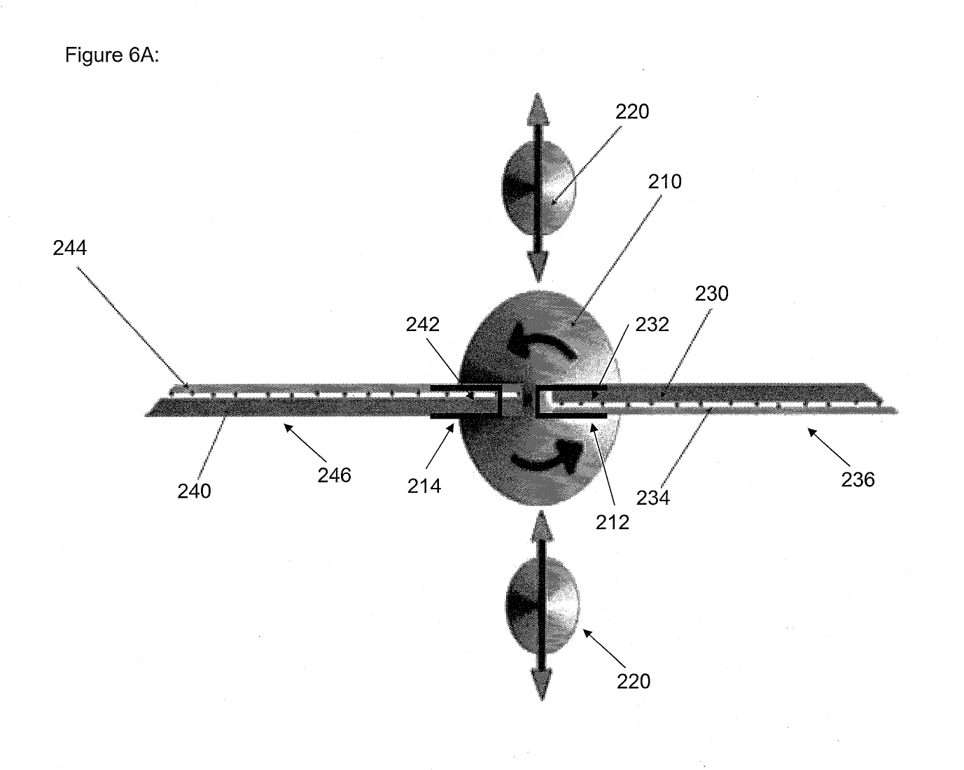

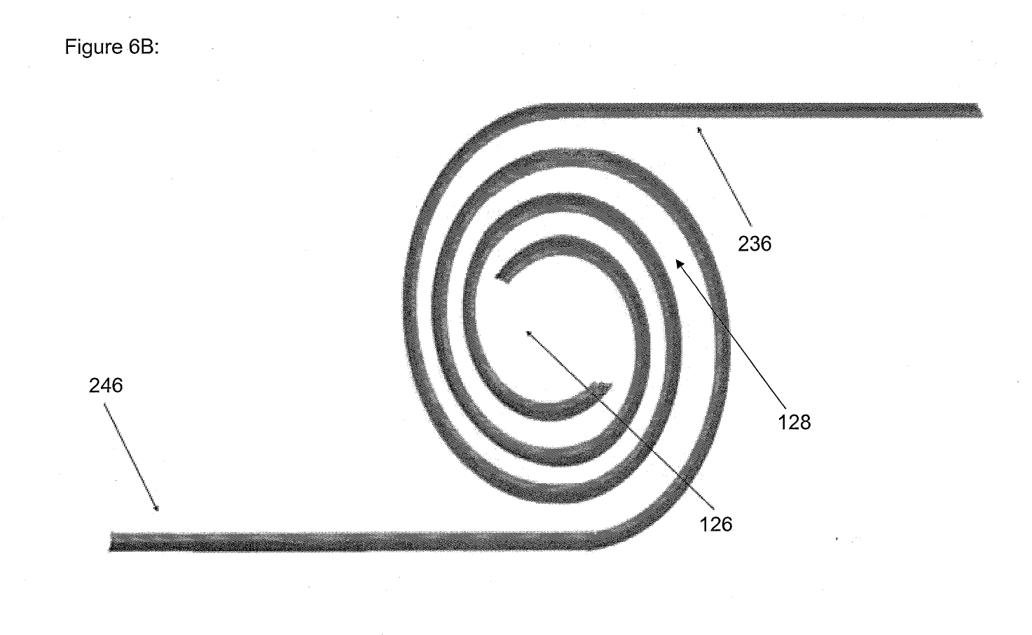

FIG. 6A schematically illustrates an example apparatus 200 for forming a target 120 comprising lithium foil in accordance with certain embodiments described herein. FIG. 6B schematically illustrates an example spiral target 120 in accordance with certain embodiments described herein. While FIGS. 6A and 6B schematically illustrate the formation of a target 120 using two lithium foils, in certain other embodiments, other numbers of lithium foils (e.g., one, three, four, or more) can also be used.

The apparatus 200 can comprise a rotatable mandrel 210 and one or more sizing rollers 220. The mandrel 210 can be configured to receive a first portion 232 (e.g., a first end) of a first lithium foil 230 and a second portion 242 (e.g., a second end) of a second lithium foil 240. In certain embodiments, the first lithium foil 230 and at least one first spacer 234 can be sandwiched together to form a first layer structure 236, and the second lithium foil 240 and at least one second spacer 244 can be sandwiched together to form a second layer structure 246. An end portion of the first layer structure 236 can be coupled to (e.g., inserted into) a first portion 212 of the mandrel 210 and an end portion of the second layer structure 246 can be coupled to (e.g., inserted into) a second portion 214 of the mandrel 210. For example, as schematically illustrated by FIG. 6A, the mandrel 210 is further configured to receive the first lithium foil 230 with the at least one spacer 234 and to receive the second lithium foil 240 with the at least one second spacer 244.

By rotating the mandrel 210 (e.g., as denoted by arrows in FIG. 6A), the first layer structure 236 (comprising the first lithium foil 230 and the at least one first spacer 234) and the second layer structure 246 (comprising the second lithium foil 240 and the at least one second spacer 244) can be wound together to form a target 120 having a spiral configuration, with the at least one first spacer 234 and the at least one second spacer 244 separating portions of the first lithium foil 230 and the second lithium foil 240 from one another. In certain embodiments, the one or more sizing rollers 220 are configured to control an outer diameter of the spiral target 120 (e.g., by providing compressive forces on the spiral target 120). In certain embodiments in which the target 120 comprises one lithium foil or more than two lithium foils (e.g., three, four, or more), the mandrel 210 can comprise a corresponding number of portions configured to receive the lithium foils (e.g., with corresponding spacers) and to wind the lithium foils to forma spiral structure.

After the target 120 is removed from the mandrel 210, the central portion of the target 120 can comprise a gas conduit 126 configured to receive tritons generated by the first lithium foil 230 and the second lithium foil 240 and configured to allow carrier gas to flow therethrough (e.g., across the lithium-containing material; across a surface of the lithium foil). In addition, regions of the target 120 between the first layer structure 236 and the second layer structure 246 can comprise one or more gas conduits 128 configured to receive tritons generated by the first lithium foil 230 and the second lithium foil 240 and configured to allow carrier gas to flow therethrough (e.g., across the lithium-containing material; across a surface of the lithium foil). The size of the one or more gas conduits 128 can be selected to be sufficient for the carrier gas to flow therethrough at a predetermined rate. The shape of the gas conduit 126 can be determined by the shape of the mandrel 210, the overall shape of the target 120 can be determined by the shape of the mandrel 210, and the size of the target 120 can be determined by the amount of lithium foil and spacers, as well as by the sizing rollers 220.

In certain embodiments, the at least one first spacer 234 and the at least one second spacer 244 comprise gas conduits 128 (e.g., pores) positioned between adjacent portions of the first lithium foil 230 and the second lithium foil 240. These gas conduits can be configured to receive tritons generated by the first lithium foil 230 and the second lithium foil 240 and to allow carrier gas to flow therethrough (e.g., across the lithium-containing material; across a surface of the lithium foil).

In certain such embodiments in which only Li metal is used, the target 120 can comprise a stainless steel container which is filled with inert gas (e.g., Ar gas) before adding the lithium metal. Certain such embodiments advantageously use such inert glove box preparation techniques to substantially exclude tritiated water (TOH) from the target 120.

In certain embodiments, the resulting lithium foil target 120 can have a total surface area that is at least four or five orders of magnitude greater than that of a single conventional target. In certain embodiments, the resulting lithium foil target 120 is configured to allow the tritium produced by neutron irradiation of the target 120 to easily diffuse, migrate, and escape from the surfaces of the target 120, thereby allowing in-situ continual production and collection of tritium gas.

### Example Collection Structure

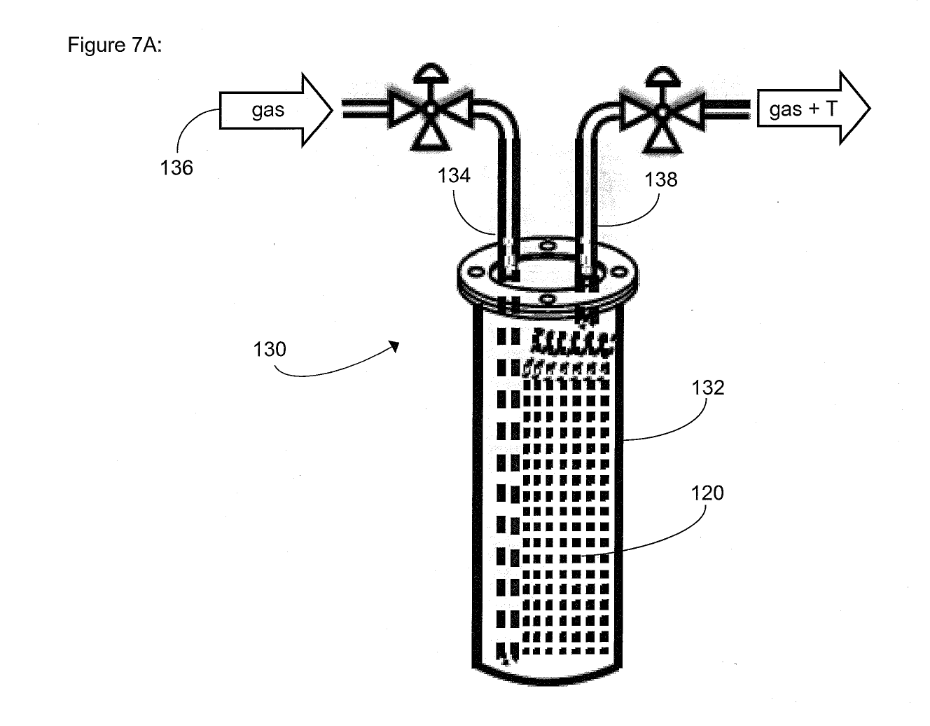

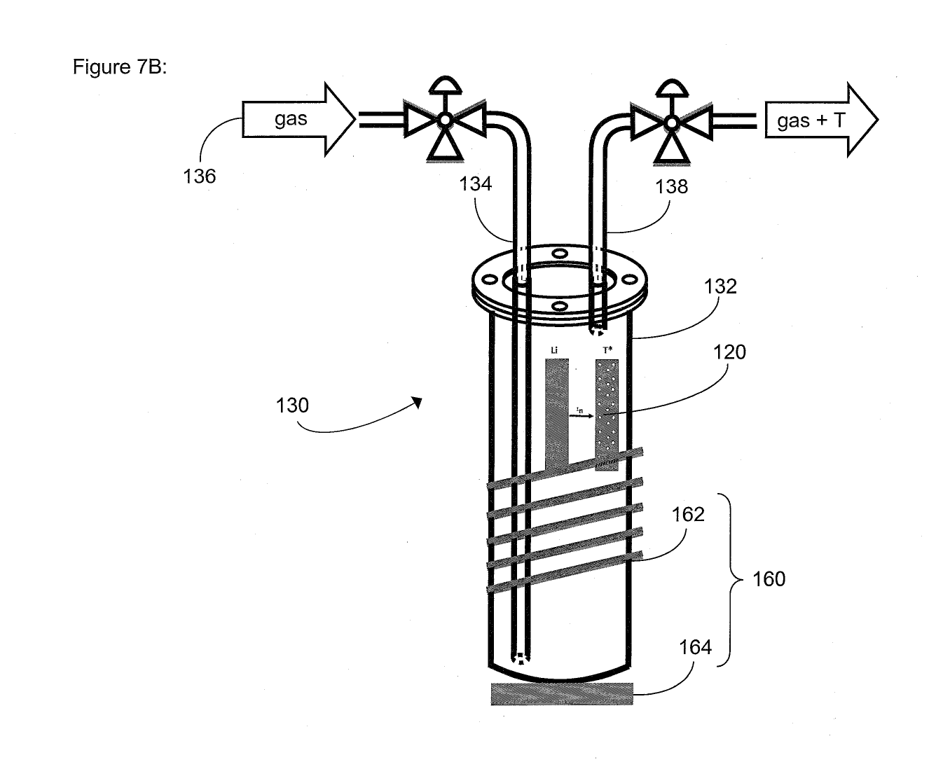

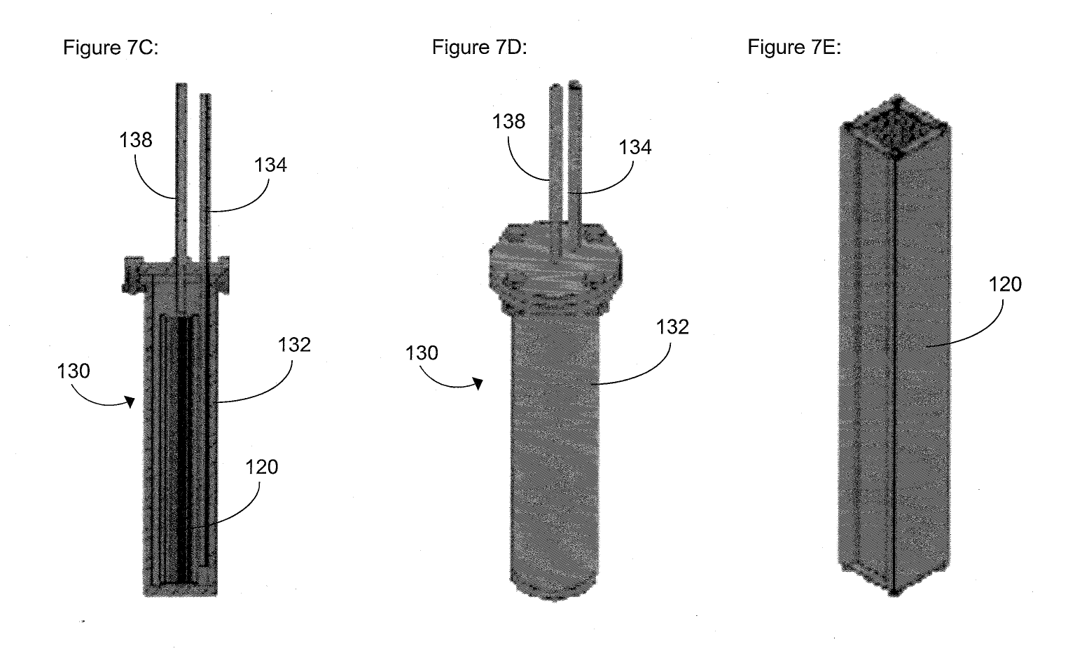

In certain embodiments, the collection structure 130 comprises at least one gas conduit 132 having an input 134 configured to receive a carrier gas 136 and an output 138 configured to allow the carrier gas 136 and the received tritium to flow out of the at least one gas conduit 132 after the carrier gas 136 has flowed along the at least one target 120 (e.g., along the lithium-containing material; along a surface of lithium foil; along a surface of the lithium metal or lithium oxide). In certain embodiments, the carrier gas 136 can comprise argon gas. In certain embodiments, the target 120 is contained within the at least one gas conduit 132. FIG. 7A-7D schematically illustrate example collection structures 130 configured to receive at least some of the tritium from the at least one target 120 in accordance with certain embodiments described herein.

In certain embodiments, the collection structure 130 can comprise low-carbon stainless steel and is formed in a manner to reduce or minimize connections (e.g., using welding to join portions of the collection structure 130 together). In certain embodiments, as schematically illustrated in FIGS. 7A-7C, the collection structure 130 can comprise two flanges configured to be bolted together with a compression metallic gasket sandwiched between the two flanges to form a seal between the two flanges. The two flanges can be unbolted from one another to provide access to the interior of the collection structure 130. In certain embodiments, as schematically illustrated by FIGS. 7A and 7B, the collection structure 130 comprises valves (e.g., stainless steel ball valves) on the input 134 and the output 138 to control the flow of the carrier gas 136 into and out of the at least one gas conduit 132.

In certain embodiments, the carrier gas 136 flows out of the input 134 in proximity to a first end of the target 120 (shown schematically in FIG. 7A as a plurality of lithium-containing pieces) and flows into the output 138 in proximity to a second end of the target 120 (see, e.g., FIGS. 7A and 7C). In this way, the output 138 can be configured to receive the carrier gas and the received tritium generated by the target 120.

In certain embodiments, the collection structure 130 further comprises at least one heating structure 160 configured to heat at least one of the carrier gas 136 flowing through the at least one gas conduit 132 and the at least one target 120. In certain embodiments, the at least one of the carrier gas and the at least one target is heated to a temperature below the melting point of lithium (e.g., 180° C.), e.g., in a range between 130° C. and 150° C. For example, the at least one heating structure 160 can comprise a plurality of heating coils 162, a heating plate 164, or both a plurality of heating coils 162 and a heating plate 164. As schematically illustrated by FIG. 7B, the heating coils 162 can be positioned around a perimeter of the collection structure 130 and the heating plate 164 can be positioned at an end of the collection structure 130.

In certain embodiments, the at least one heating structure 160 can be configured to heat the target 120. Certain such embodiments can advantageously facilitate in situ recovery of tritium from the lithium-containing material of the target 120 by applying thermal energy (e.g., below the melting temperature of the lithium-containing material) to drive tritons out of the lithium (e.g., out of the lithium metal matrix). For example, the plurality of heating coils 162 can be positioned in proximity to the target 120 (shown schematically in FIG. 7B as a lithium-containing material which upon neutron irradiation produces tritons).

FIG. 7E schematically illustrates an example target 120 compatible to be used with the collection structures 130 of FIGS. 7A-7D. In certain embodiments, the target 120 can be configured to hold the lithium-containing material so as to allow the carrier gas 136 to flow through regions which receive the tritium generated by the lithium-containing material (e.g., along the surfaces of the lithium-containing material). For example, the target 120 can comprise slots which contain a plurality of strips of lithium metal spaced from one another to allow the carrier gas to flow across the surfaces of the lithium metal strips. In an example configuration, the target 120 can comprise 9 strips of lithium metal, with a surface area per strip of 80 cm², a strip thickness of 0.07 cm, thereby providing a total lithium metal surface area of 716 cm² and a total lithium metal mass of 12.1 g. Other configurations of the target 120 are also compatible with producing tritium from lithium in accordance with certain embodiments described herein.

As a result of neutron bombardment, ⁶Li nuclei in the target 120 are converted to tritium (T) and helium (He) gases. In certain embodiments, the collection structure 130 comprises a getter material (e.g., reversible metallic hydrides; depleted uranium; Zr) configured to trap the T gas while rejecting the He gas (e.g., Zr+xT→ZrTₓ). In certain embodiments, a membrane (e.g., an inorganic membrane, such as those developed by Oak Ridge National Laboratory) may be used for the separation and collection of tritium that is produced in the form of tritiated water (TOH). In certain embodiments, one or both of the target 120 and the collection structure 130 can comprise a monitoring system which utilizes a getter material (e.g., reversible metallic hydrides; depleted uranium; Zr) to provide in-line, real-time continual measurements to assess the tritium production as functions of neutron intensity (e.g., fluence), natural lithium mass (e.g., surface area), temperature of the lithium mass, and/or irradiation period.

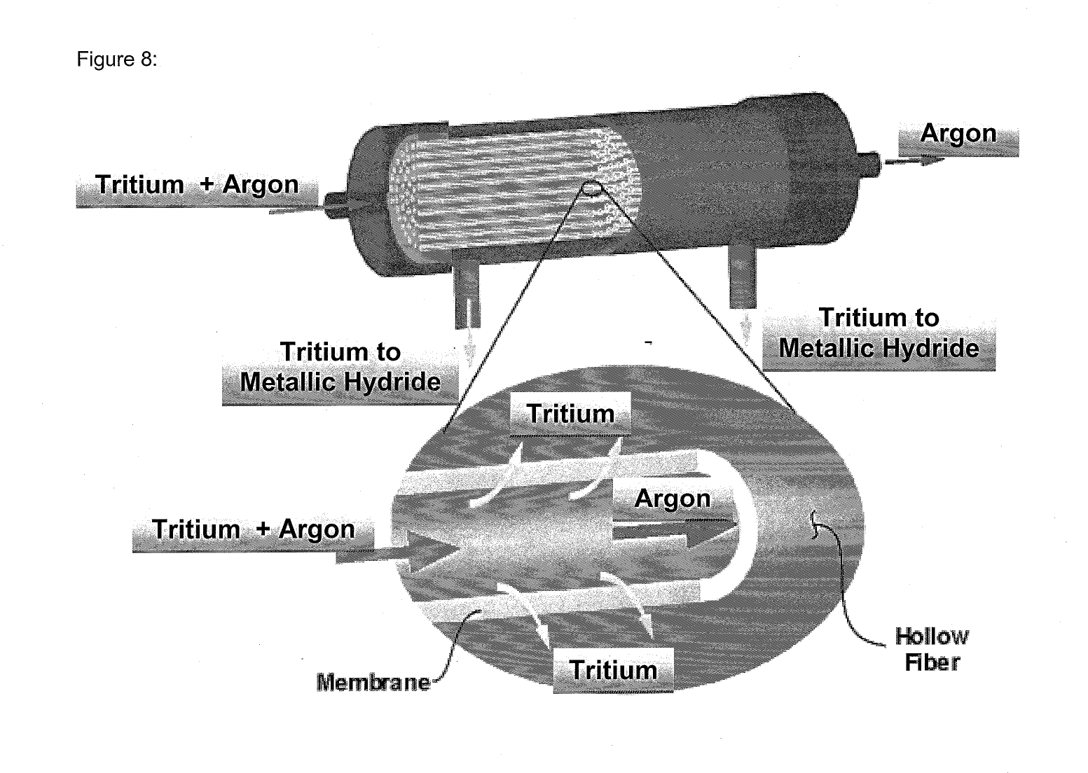

FIG. 8 schematically illustrates an example separation structure in accordance with certain embodiments described herein. In certain embodiments the separation structure comprises a housing, a plurality of gas conduits (e.g., hollow fiber tubes) within the housing, an input, one or more tritium outputs, and one or more carrier gas outputs. The plurality of gas conduits comprises a plurality of membranes (e.g., walls) that selectively allow tritium to pass through the membranes while preventing the carrier gas (e.g., argon) from passing through the membranes. In certain embodiments, the carrier gas and tritium mixture (e.g., argon and tritium mixture) flows out of the output 138 of the target 120 and into the input of the separation structure. The carrier gas and tritium mixture is directed to flow through the plurality of gas conduits (e.g., hollow fiber tubes) such that the tritium passes through the membranes while the argon does not pass through the membranes. After having flowed through the plurality of gas conduits, the carrier gas is directed to flow out of the housing via the one or more carrier gas outputs. After having passed through the plurality of membranes, the tritium is directed to flow out of the housing via the one or more tritium outputs to a storage structure (e.g., comprising metallic hydride) where the tritium can be stored. Other configurations of a separation structure are also compatible with certain embodiments described herein.

### Example Neutron Multipliers and Neutron Reflectors

In certain embodiments, the system 100 further comprises at least one neutron multiplier 140 configured to generate neutrons in response to being irradiated by neutrons. Example neutron multipliers 140 can comprise one or more of the following: Be(n, 2n); Pb(n, 2n); ⁷Li(n, n′t); natural uranium; depleted uranium; reactor fuel. In certain embodiments, the system 100 further comprises at least one neutron reflector 150 configured to redirect at least some neutrons impinging the at least one neutron reflector 150. Example neutron reflector 150 in accordance with certain embodiments described herein can comprise graphite. The at least one target 120 is configured to be irradiated by at least some of the neutrons from the at least one neutron multiplier 140 and at least some of the neutrons redirected by the at least one neutron reflector 150.

### Example System Configurations

In certain embodiments, various example system configurations can be used for the tritium production system 100. In certain embodiments, the system 100 includes at least one neutron multiplier 140 (e.g., at least one depleted uranium (DU) reflector block, at least one DU blanket boxes), at least one neutron reflector 150, and at least one neutron-absorbing elements (e.g., comprising polyethylene materials). These components can be compiled together in various geometrical configurations to produce different neutron spectra (e.g., to produce optimal tritium production using the natural lithium metal targets 120). In certain embodiments, the purpose of optimization of the neutron spectrum is to enable every neutron of all energies to interact with the lithium to enhance tritium production.

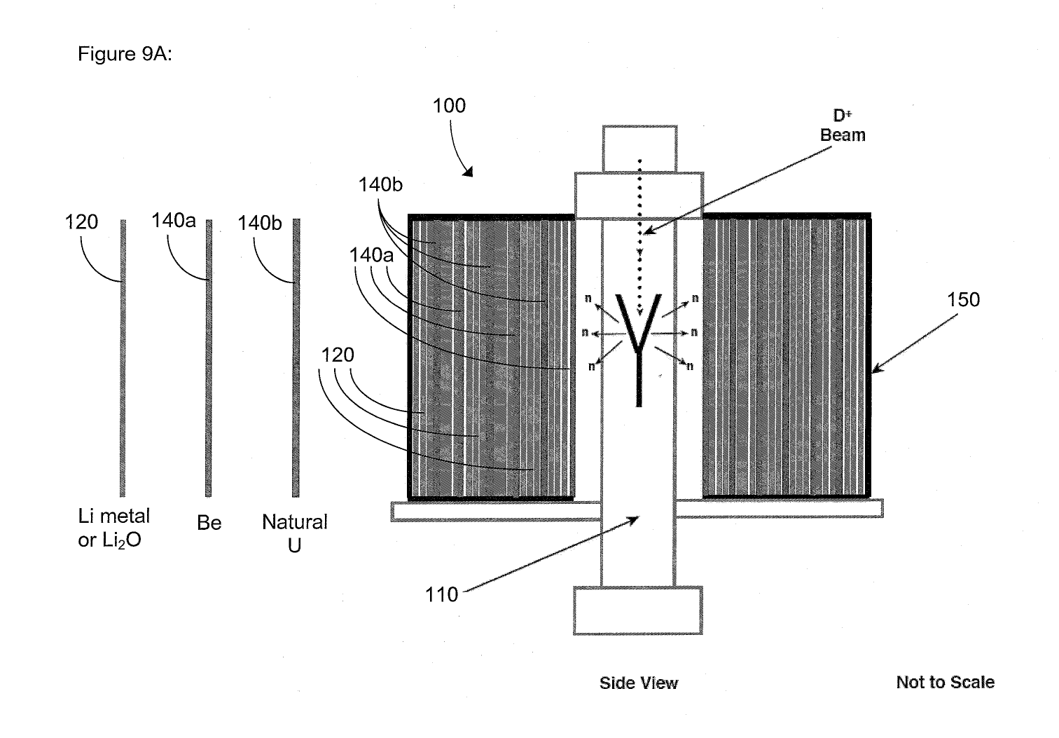

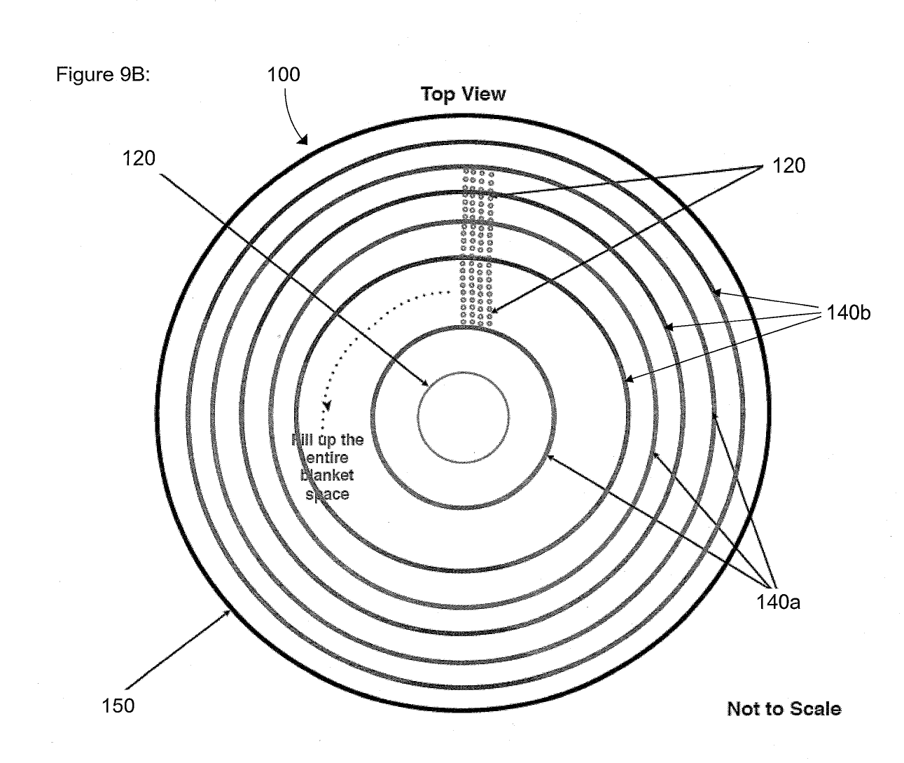

FIG. 9A is a schematic side view of an example system 100 in accordance with certain embodiments described herein. FIG. 9B is a schematic top view of the example system 100 of FIG. 9A in accordance with certain embodiments described herein. The example system 100 of FIGS. 9A and 9B comprises a neutron generator 110 (e.g., a limitless-life neutron generator) configured to direct a beam of D⁺ ions to irradiate a neutron source (e.g., D or T) and configured to emit neutrons upon being irradiated by the beam of D⁺ ions. At least some of the generated neutrons propagate outwardly from the neutron generator 110 to impinge the at least one target 120.

In the example system 100 of FIGS. 9A and 9B, the neutron generator 110 has a generally cylindrical structure and is surrounded by a plurality of neutron multipliers 140 and a plurality of targets 120. The neutron multipliers 140 can comprise a plurality of structures 140a (e.g., cylinders) comprising beryllium and/or a plurality of structures 140b (e.g., cylinders) comprising natural uranium. While FIGS. 9A and 9B show the plurality of Be-containing structures 140a alternating in the radial direction with the plurality of U-containing structures 140b, other configurations are also compatible with certain embodiments described herein. In certain embodiments, the objective of the neutron multiplier is to enhance and increase the production of tritium from lithium.

In the example system of FIGS. 9A and 9B, the targets 120 comprise elongate structures (e.g., tubes; rods) containing a lithium-containing material (e.g., lithium metal or lithium oxide), and are oriented generally parallel to the beam of D⁺ ions of the neutron generator 110. These lithium-containing elongate structures (e.g., rods comprising LiO₂) are packed between the neutron multipliers 140 (e.g., between the Be-containing structures 140a and the U-containing structures 140b), and these regions containing the packed lithium-containing elongate structures can be termed “lithium blankets.” In the example system 100 of FIGS. 9A and 9B, the neutron generator 110, the targets 120, and the neutron multipliers 140 are generally surrounded by a neutron reflector 150 (e.g., graphite) configured to reflect at least a portion of the neutrons towards the targets 120.

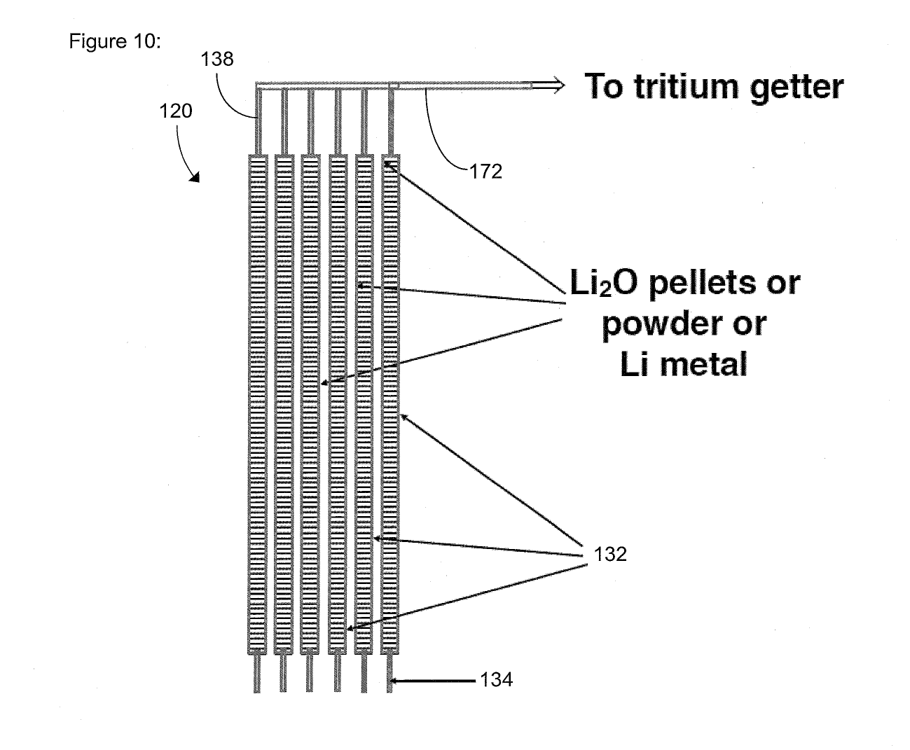

FIG. 10 is a schematic view of a plurality of lithium-containing elongate structures to be used as targets 120 in accordance with certain embodiments described herein. These targets 120 can be configured to facilitate tritium breeding and collection and can comprise a lithium-containing material (e.g., LiO₂ pellets or powder; Li metal) and at least one collection structure 130. For example, each elongate structure of the target 120 can comprise an input 134 configured to receive a carrier gas 136 (e.g., argon), a gas conduit 132 (e.g., steel tube) which contains the lithium-containing material, and an output 138 configured to allow the carrier gas 136 and the received tritium to flow out of the elongate structure into a manifold 172 for collection. The gas conduit 132 (e.g., tube) of the elongate structure can comprise reduced activation martensitic steel (e.g., EUROFER steel tube; see, e.g., A-A. F. Tavossoli et al., “Materials design data for reduced activation martensitic steel type,” J. Nuclear Mat'l, Vols. 329-333, Proc. of 11^{th} Int'l Conf. on Fusion Reactor Mat'ls, pp. 257-262 (2004)) in which the lithium-containing material is contained. The gas conduit 132 can be configured to allow the carrier gas 136 to propagate along (e.g., through) the lithium-containing material from the input 134 to the output 138. The carrier gas 136, along with any tritium gas picked up by the carrier gas 136 while flowing through the elongate structure, can be collected at the manifold 172 and directed to flow through a separation structure (e.g., as shown in FIG. 8). The tritium from the separation structure can be directed towards a tritium storage structure comprising one or more materials (e.g., foam; Ti getter; cryogenic collector; metallic sponges; metallic hydrides) configured to store the tritium.

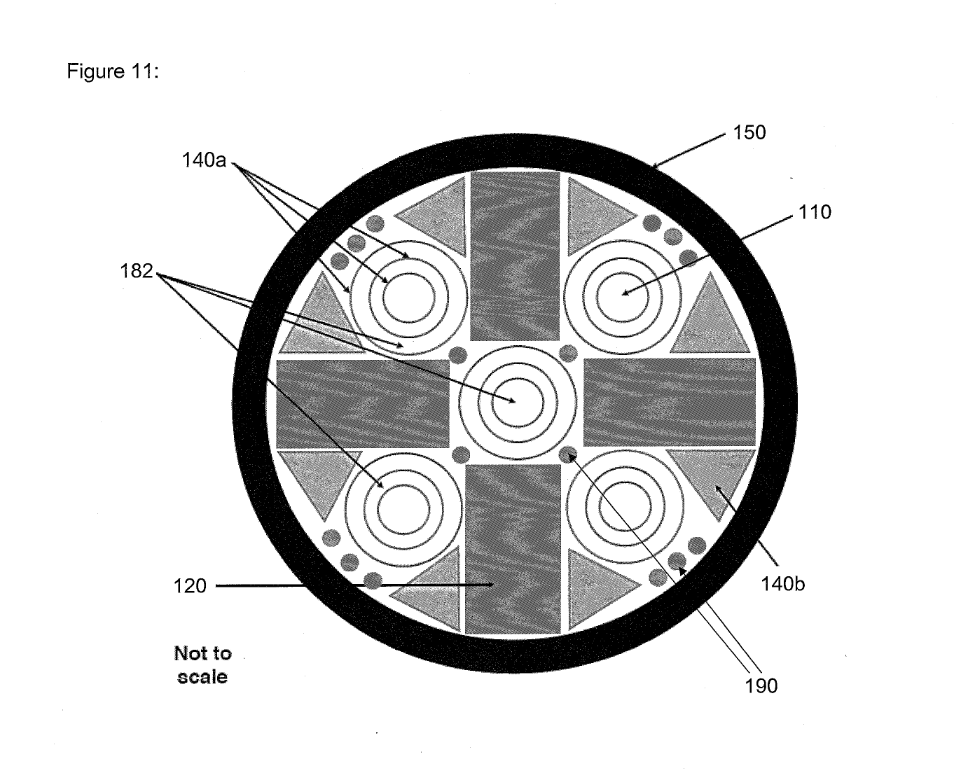

FIG. 11 is a schematic top view of another example system 100 in accordance with certain embodiments described herein. The example system 100 of FIG. 11 uses a five-unit design which can maximize production efficiency. The example system 100 comprises five neutron generators 110, each of which has a generally cylindrical structure, is positioned generally at the center of its respective unit, and is surrounded by a plurality of neutron multipliers 140 and a plurality of targets 120. The neutron multipliers 140 can comprise a plurality of Be-containing structures 140a (e.g., cylinders) and the plurality of targets 120 can be positioned within multiple lithium-containing zones 182 surrounding the neutron generator 110 (e.g., between the neutron generator 110 and the Be-containing structures 140a; between the Be-containing structures 140a). In addition, the example system 100 of FIG. 11 can comprise a plurality of other lithium-containing targets 120 (e.g., comprising natural Li₂O) between the neutron generators 110 and other neutron multipliers 140b (e.g., comprising natural uranium; reactor fuel) positioned between the other lithium-containing targets 120 and the neutron generators 110. In the example system 100 of FIG. 11, the neutron generators 110, the lithium-containing targets 120, and the neutron multipliers 140 are generally surrounded by a neutron reflector 150 (e.g., graphite) configured to reflect at least a portion of the neutrons towards the targets 120. In addition, the example system 100 of FIG. 11 can comprise a plurality of cooling channels 190 through which a coolant (e.g., air) can flow to remove heat from the system 100 (e.g., from each unit containing a neutron generator 110). While FIG. 11 shows a particular configuration of the neutron generators 110, lithium-containing targets 120, neutron multipliers 140, and neutron reflector 150, other configurations are also compatible with certain embodiments described herein.

### Example Approximations of Performance

The cross section for ⁶Li shown in FIG. 3A can be approximated by an assumption that one neutron of all energies interacting with ⁶Li will produce 1 triton. Furthermore, in certain embodiments, the following calculations and/or assumptions may be made to characterize the expected performance:
1 Mole of ⁶Li (6 grams)=>1 Mole Tritium (3 grams)
1 Mole of T=>6.023×10²³ nuclei
Neutron generator=>3×10⁹ neutrons/second
1 hour of operation=>3×10⁹×3600=>˜1×10¹³ neutrons
In one hour of operations, 10¹³ neutrons=>10¹³ triton nuclei.
Tritium half-life=>12.33 years
Activities=λN
N=10¹³ triton nuclei
Activity after 1 hour of irradiation with 2 Moles of ⁶Li=
   =10¹³×0.693/(12.33×365×24×3600) dps
   =10⁷ dps (beta decay)
   This activity can be detected by either with a typical beta liquid scintillation counter or with a RGA spectrometer.
If the neutron generator produces 10¹³ neutrons/second, then in one hour, 10¹⁷ nuclei of tritium will be produced.
   For 1000 hours (˜1.4 months) of non-stop irradiation, the system can produce 10²⁰ nuclei of tritium.
   With one or more neutron multipliers and multiplicity (e.g., DU (fast fission), Natural U oxide (thermalized and fast fission), and Be (n,2n)), a multiplication of about >100 can be achieved=>˜10²² nuclei of tritium.
   A non-stop 14 months of operation can produce 10²³ nuclei of tritium (˜1 Mole).
   A 10-unit cluster can produce >10²⁴ nuclei of tritium=>˜10 Moles/14-month cycle (30 grams).
   Projected US Tritium needs=>˜1000 Moles/18-month cycle (3000 grams).
   One 10-unit cluster of such systems can provide 1/100 US tritium needs.
Cost estimates can be made: Setup Costs (one 10¹³ n/s neutron generator=˜$250 K; material cost=˜$200 K/unit; setup=˜$3.0 M; 10-unit cluster setup and material cost=>$7.5 M) and estimated yearly operational cost to produce 10 Moles of tritium with a 10-unit cluster is about $5.0 M. Other estimates will vary depending on various parameters, including the costs of materials such as the cost of lithium.

Although described above in connection with particular embodiments, it should be understood the descriptions of the embodiments are illustrative of the invention and are not intended to be limiting. Various modifications and applications may occur to those skilled in the art without departing from the true spirit and scope of the invention as defined by the claims.

What is claimed is:

1. A system for producing tritium, the system comprising:
at least one neutron generator configured to generate neutrons;
at least one target comprising a lithium-containing material, the at least one target configured to be irradiated by at least some of the neutrons and to produce tritium; and
at least one collection structure configured to receive at least some of the tritium from the at least one target, the at least one collection structure comprising at least one gas conduit having an input configured to receive a carrier gas and an output configured to allow the carrier gas and the received tritium to flow out of the at least one gas conduit after the carrier gas has flowed along the at least one target.

2. The system of claim 1, wherein the lithium-containing material comprises lithium metal or lithium oxide having an isotope abundance ratio of ⁶Li:⁷Li equal to or greater than 7.5:92.5.

3. The system of claim 1, wherein the at least one neutron generator comprises at least one limitless-life neutron generator.

4. The system of claim 1, further comprising:
at least one neutron multiplier configured to generate neutrons in response to being irradiated by neutrons; and
at least one neutron reflector configured to redirect at least some neutrons impinging the at least one neutron reflector, wherein the at least one target is configured to be irradiated by at least some of the neutrons from the at least one neutron multiplier and at least some of the neutrons redirected by the at least one neutron reflector.

5. The system of claim 4, wherein the at least one neutron multiplier comprises at least one of beryllium and depleted uranium.

6. The system of claim 4, wherein the at least one neutron reflector comprises graphite.

7. The system of claim 1, wherein the lithium-containing material is contained within the at least one collection structure.

8. The system of claim 1, wherein the at least one collection structure further comprises a tritium, getter material.

9. The system of claim 1, wherein the carrier gas comprises argon gas.

10. The system of claim 9, wherein the at least one of the carrier gas and the at least one target is heated to a temperature in a range between 130° C. and 150° C.

11. A method for producing tritium, the method comprising:
irradiating at least one target with neutrons, the at least one target comprising a lithium-containing material, the at least one target configured to produce tritium in response to neutron irradiation;
flowing a carrier gas along the at least one target, the carrier gas configured to receive at least some of the tritium; and
collecting the carrier gas and the received tritium after the carrier gas has flowed along the at least one target.

12. The method of claim 11, wherein the lithium-containing material comprises lithium metal or lithium oxide having an isotope abundance ratio of ⁶Li:⁷Li equal to or greater than 7.5:92.5.

13. The method of claim 11, wherein the carrier gas comprises argon gas.

14. The method of claim 14, wherein the at least one of the carrier gas and the at least one target is heated to a temperature in a range between 130° C. and 150° C.

15. The method of claim 11, further comprising:
generating a first plurality of neutrons, wherein irradiating the at least one target with neutrons comprising irradiating the at least one target with at least some of the first plurality of neutrons;
irradiating at least one neutron multiplier with a first portion of the first plurality of neutrons to generate a second plurality of neutrons, wherein irradiating the at least one target with neutrons comprises irradiating the at least one target with at least some of the second plurality of neutrons; and
redirecting at least some of the first plurality of neutrons and at least some of the second plurality of neutrons to propagate towards the at least one target, wherein irradiating the at least one target with neutrons comprises irradiating the at least one target with at least some of the redirected neutrons.

16. The method of claim 15, wherein generating the first plurality of neutrons comprises irradiating a neutron source with deuterium ions, the neutron source comprising deuterium, tritium, or both.

17. The method of claim 15, wherein the at least one neutron multiplier comprises at least one of beryllium and depleted uranium.

18. The method of claim 15, wherein said redirecting comprises irradiating at least one neutron reflector with the at least some of the first plurality of neutrons and the at least some of the second plurality of neutrons, the at least one neutron reflector comprising graphite.

19. A system for producing tritium, the method comprising:
means for irradiating at least one target with neutrons, the at least one target comprising a lithium-containing material, the at least one target configured to produce tritium in response to neutron irradiation;
means for flowing a carrier gas along the at least one target, the carrier gas configured to receive at least some of the tritium; and
means for collecting the carrier gas and the received tritium after the carrier gas has flowed along the at least one target.
